(19) United States
(12) Patent Application Publication
(10) Pub. No.: US 2014/0062855 A1
(43) Pub. Date: Mar. 6, 2014

(54) FITNESS APPARATUS CAPABLE OF PROJECTION

(71) Applicant: DYACO INTERNATIONAL INC., Taipei City (TW)

(72) Inventors: Hsuan-Fu HUANG, Hemei Town (TW); Ching-Lung LIAO, Hemei Town (TW)

(73) Assignee: DYACO INTERNATIONAL INC., Taipei City (TW)

(21) Appl. No.: 13/665,360

(22) Filed: Oct. 31, 2012

(30) Foreign Application Priority Data
Sep. 6, 2012 (TW) 101132571

(51) Int. Cl. G09G 5/00

(52) U.S. Cl. 345/156

(57) ABSTRACT

A fitness apparatus includes a framework, a control panel, and a microprojector. The framework includes a chassis and a handrail stand mounted to the chassis. The control panel is mounted to the handrail stand for displaying a variety of physical states in the process of the user's exercise. The microprojector is electrically connected with the control panel for projecting built-in information of the control panel or external information received by the control panel in such a way that the user can conveniently view the information and enjoy more fun.

### BACKGROUND OF THE INVENTION

1. Field of the Invention

The present invention relates generally to a fitness apparatus, and more particularly, to a fitness apparatus capable of projection.

2. Description of the Related Art

The existing fitness apparatus, like treadmill, usually includes a control panel for a user to configure a variety of parameters, such as running time, running velocity, running distance, and running gradient, to reach the optimal exercise effect. Besides, the control panel can be connected with a smart phone or an electronic device for playback of music or films for more fun while the user is running.

However, the control panel is usually not too big and lower than the user's eyes, so the user needs to bow his or her head to see a variety of the information shown on the control panel in such a way that the user not only operates it inconveniently but easily hurts his or her neck while running and bowing the head at the same time. To eliminate such drawback, U.S. Pat. Pub. No. 2004/0147369 disclosed a gymnastic and sports apparatus comprising a stereoscopic projection screen for external connection with a projector for projection on the bigger screen. However, such design needs great space, so the overall practicability is not high.

### SUMMARY OF THE INVENTION

The primary objective of the present invention is to provide a fitness apparatus capable of projection, which can project a variety of information shown thereon via a microprojector to enable the user to view the information conveniently.

The foregoing objective of the present invention is attained by the fitness apparatus composed of a framework, a control panel, and a microprojector. The framework includes a chassis and a handrail stand mounted to the chassis. The control panel is mounted to the handrail stand for displaying a variety of physical information in the process of the user's exercise. The microprojector is electrically connected with the control panel for projecting the information shown on the control panel for the purpose of the user's convenient view and more recreational effects.

In a preferred embodiment of the present invention, the microprojector can be selectively mounted to a frame of the control frame or the handrail stand.

In a preferred embodiment of the present invention, the microprojector can project one built-in information of the control panel, or one external information received via a signal port by the control panel, or even an external information received straight therefrom.

### BRIEF DESCRIPTION OF THE DRAWINGS

FIG. 1 is a perspective view of a preferred embodiment of the present invention applied to a treadmill at work.

FIG. 2 is a front view of the preferred embodiment of the present invention.

FIG. 3 is a front view of a second preferred embodiment of the present invention, illustrating where the microprojector is installed differently.

FIG. 4 is a block diagram of the present invention.

FIG. 5 is a perspective view of a third preferred embodiment of the present invention applied to an elliptical machine.

FIG. 6 is a perspective view of a fourth preferred embodiment of the present invention applied to an exercise bike.

### DETAILED DESCRIPTION OF PREFERRED EMBODIMENTS

Structural features and desired effects of the fitness apparatus of the present invention will become more fully understood by reference to four preferred embodiments given hereunder. However, it is to be understood that these embodiments are given by way of illustration only, thus are not limitative of the claim scope of the present invention.

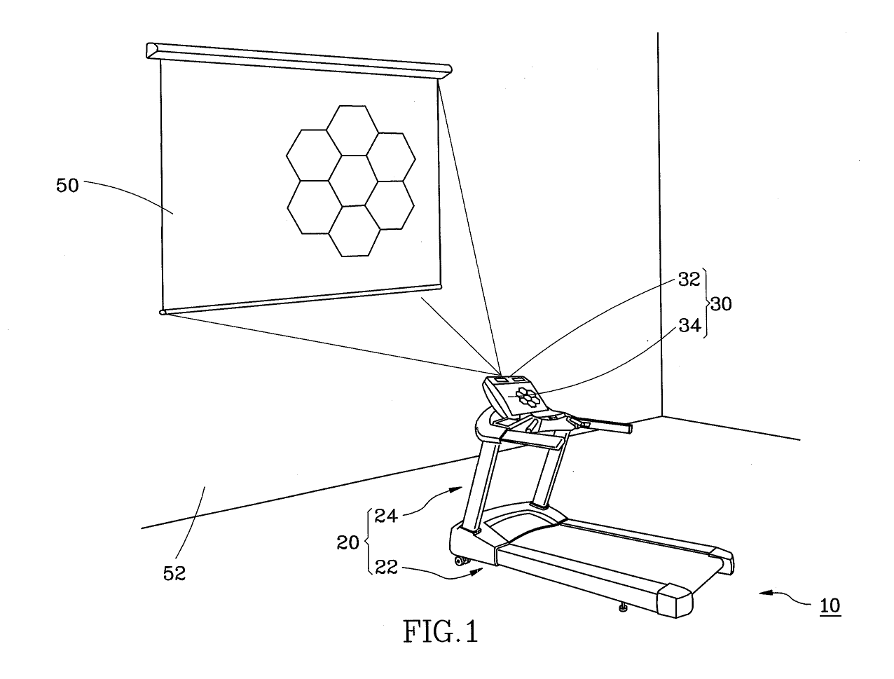

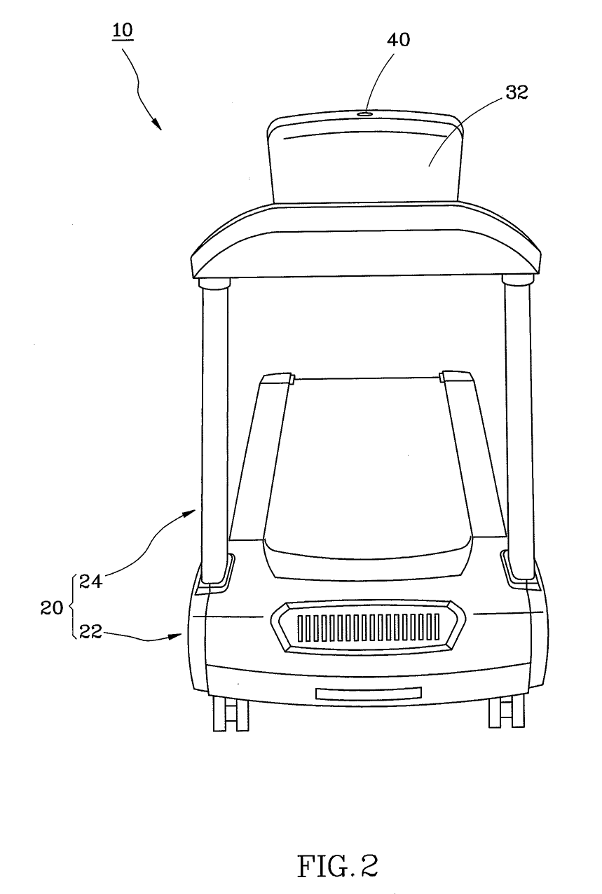

Referring to FIGS. 1-2, a fitness apparatus 10 constructed according to a first preferred embodiment of the present invention is composed of a framework 20, a control panel 30, and a microprojector 40. The fitness apparatus 10 is a treadmill as an example in this embodiment. The detailed descriptions and operations of these elements as well as their interrelations are recited in the respective paragraphs as follows.

The framework 20 includes a chassis 22 and a handrail stand 24. The chassis 22 is put on the ground for supporting other components of the fitness apparatus 10. The handrail stand 24 is fixed to a front end of the chassis 22 for the user's handhold.

The control panel 30 is provided for the user to configure a variety of parameters of operation of the fitness apparatus 10, such as power switch, operational speed, and operational time. The control panel 30 includes a frame 32 and a display screen 34. The frame 32 is fixed to the handrail stand 24. The display screen 34 is mounted inside the frame 32 for displaying various information.

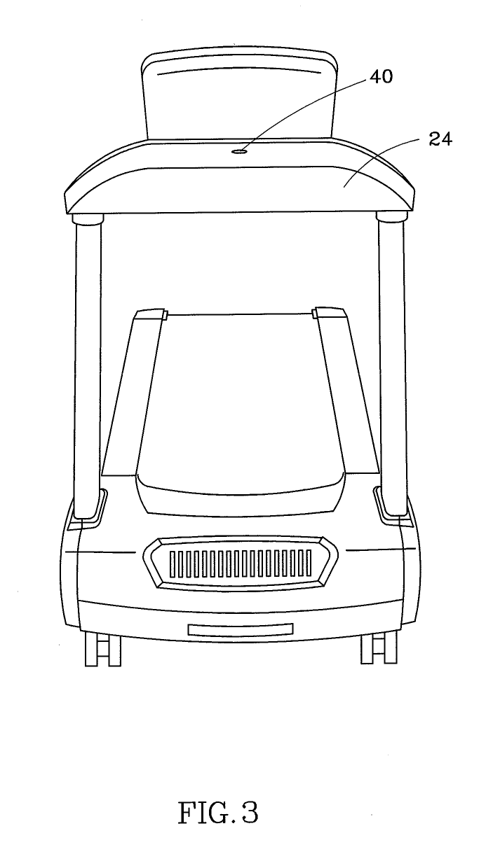

The microprojector 40 is embedded into the frame 32 in this embodiment, as shown in FIG. 2, and is electrically connected with the control panel 30 for projecting what is shown on the display screen 34 to a projection screen 50 or a wall 52. For the record, there are many methods for installing the microprojector 40 into but not limited to the frame 32 of the control panel 30. For example, the microprojector 40 can be installed onto the handrail 23, as shown in FIG. 3, in accordance with a second preferred embodiment of the present invention. The microprojector 40 can even be structurally detachable to become conveniently portable.

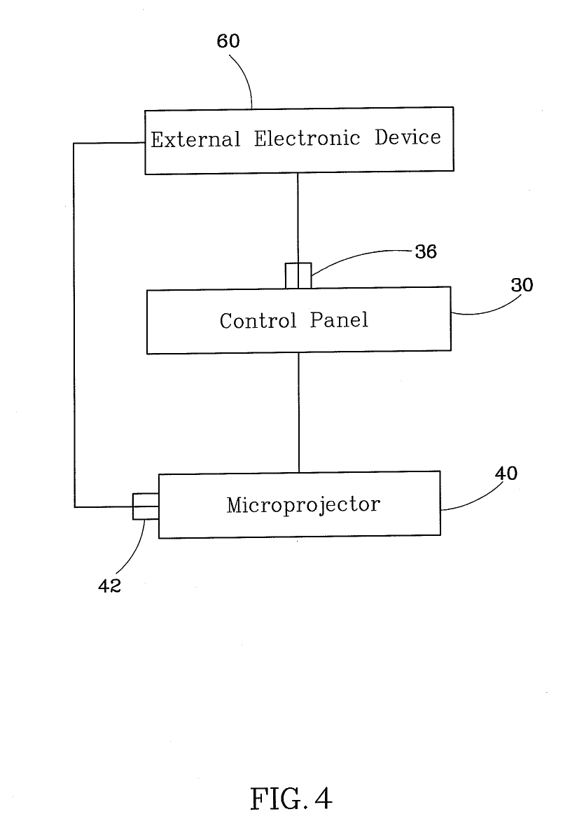

When the fitness apparatus 10 is operated, as shown in FIG. 4, a variety of immediate physical information, like time, velocity, distance, heartbeat rate, and consumed calories, shown on the control panel 30 can be projected via the microprojector 40 onto the projection screen 50 for the user's convenient view for further operation. Besides, the user can also make one built-in information, like multimedia video, of the control panel 30 be projected straight onto the projection screen 50 via the microprojector 40. Furthermore, the microprojector 40 can be connected with an external electronic device 60 (e.g. smart phone, digital camera, or digital video camera) via a signal port 36, like AV (audio and video) terminal, HDMI (high definition multimedia interface) terminal, VGA (video graphics array) terminal, Mini USB (universal serial bus) terminal, or DVI (digital video interactive) terminal and then external information, like music, photos, or multimedia videos, received by the external electronic device 60 can be transmitted to the control panel 30 to be projected by the microprojector 40 onto the projection screen 50 or the wall 52. In addition, the microprojector 40 can be connected with the external electronic device 60 via a signal port 42 thereof, like AV terminal, HDMI terminal, VGA terminal, Mini USB terminal, or DVI terminal and the external information, like music, photos, or multimedia videos, received by the external electronic device 60 can be projected by the microprojector 40 onto the projection screen 50 or the wall 52. In this way, there will be more fun and less boring perception in the process of the user's exercise.

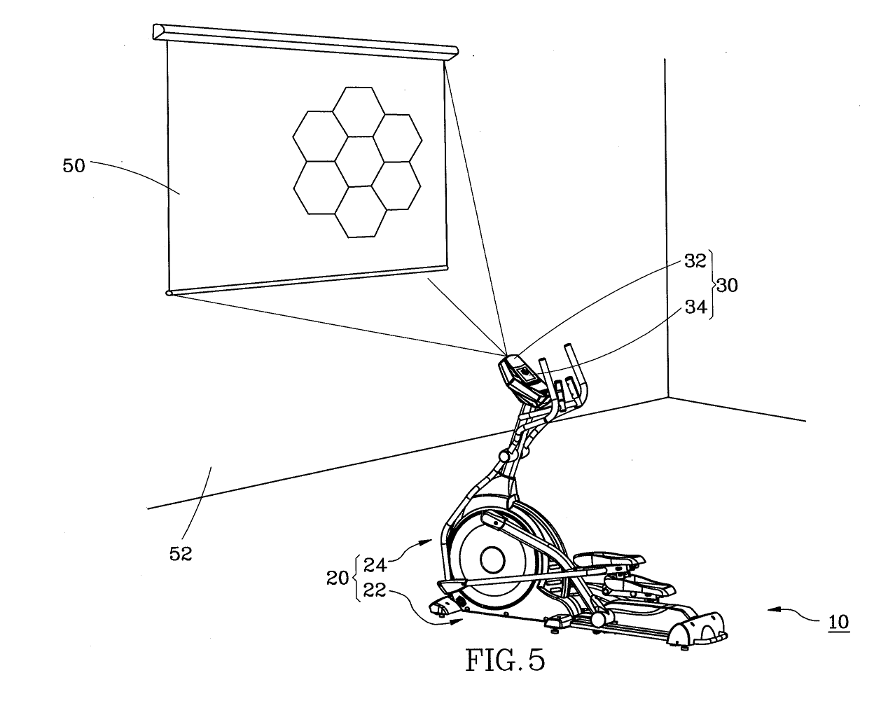

In conclusion, the fitness apparatus 10 of the present invention can amplify the watching screen via the microprojector 40 to not only save more operational space but to play a variety of information according to the user's needs, thus being very convenient for operation. However, it is to be noted that the fitness apparatus 10 of the present invention is not limited to the treadmill but can be an elliptical machine shown in FIG. 5 in accordance with a third preferred embodiment or an exercise bike shown in

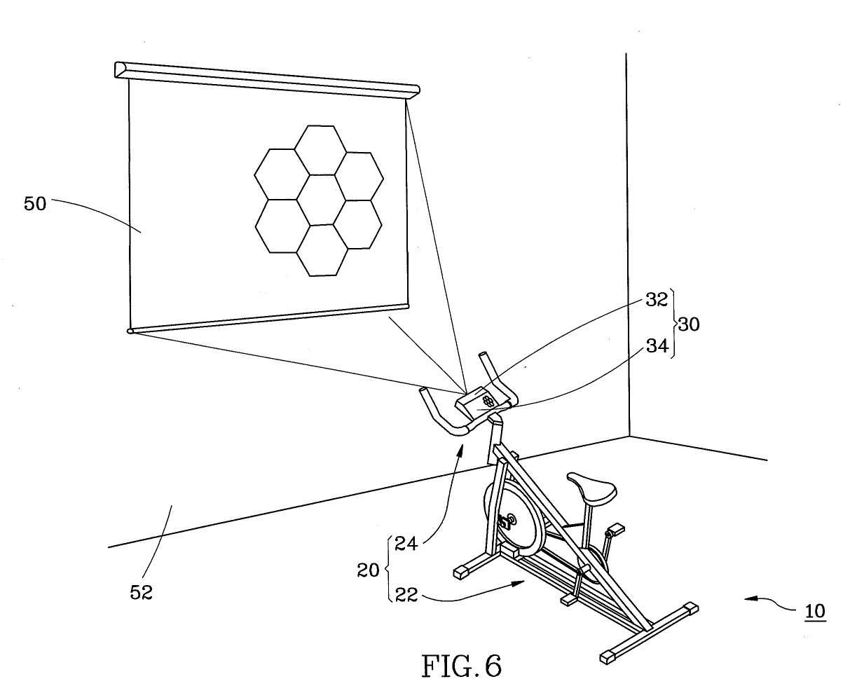

FIG. 6 in accordance with a fourth preferred embodiment.

What is claimed is:

1. A fitness apparatus capable of projection, comprising:
a framework having a chassis and a handrail stand mounted to a front end of the chassis;
a control panel mounted to the handrail stand; and
a microprojector electrically connected with the control panel for projecting information shown on the control panel under control of the control panel.

2. The fitness apparatus as defined in claim 1, wherein the microprojector can be selectively installed to the chassis or the control panel.

3. The fitness apparatus as defined in claim 2, wherein the microprojector is fixed to the handrail stand.

4. The fitness apparatus as defined in claim 2, wherein the microprojector is embedded into a frame of the control panel.

5. The fitness apparatus as defined in claim 1, wherein the control panel comprises one built-in information therein and the microprojector can be controlled by the control panel to project the built-in information.

6. The fitness apparatus as defined in claim 1, wherein the control panel can receive one external information via a signal port and the microprojector can be controlled by the control panel to project the external information.

7. The fitness apparatus as defined in claim 1, wherein the microprojector can receive one external information via a signal port and project the external information.

8. The fitness apparatus as defined in claim 7, wherein the signal port is audio and video (AV) terminal, high definition multimedia interface (HDMI) terminal, video graphics array (VGA) terminal, mini universal serial bus (USB) terminal, or digital video interactive (DVI) terminal.
